(19) United States
(12) Patent Application Publication
(10) Pub. No.: US 2007/0272091 A1
(43) Pub. Date: Nov. 29, 2007

(54) Manual juice extruder

(76) Inventor: Lai-Cheng Hsien, Xinzhuang City (TW)

Correspondence Address: BACON & THOMAS, PLLC, 625 SLATERS LANE, FOURTH FLOOR, ALEXANDRIA, VA, 22314, US

(21) Appl. No.: 11/802,287

(22) Filed: May 22, 2007

(30) Foreign Application Priority Data
May 26, 2006 (TW) 095209143

(51) Int. Cl. A47J 43/14

(52) U.S. Cl. 99/501

(57) ABSTRACT

A manual juice extruder is used as a tool for extruding fruit juice and includes a juice-extruding tray. The central position of the juice-extruding tray has a raised portion that protrudes upwardly. The periphery of the raised portion has a plurality of protruding ribs. The center of the raised portion has an opening. The periphery of the opening has at least one skid-proof piercing portion that protrudes upwardly. Via this arrangement, when the user extrudes the juice manually, the fruit body can be fixed on the raised portion, which facilitates the extrusion of the juice.

### BACKGROUND OF THE INVENTION

1. Field of the Invention

The present invention relates to a manual juice extruder, and in particular to a manual juice extruder for fixing a fruit to be extruded.

2. Description of Prior Art

Existing juice extruders are divided into electric juice extruders and manual juice extruders. The electric juice extruder can save labors but the price thereof is more expensive. Further, it is necessary to consume electricity to use the electric juice extruder. In addition, it is not easy to clean the electric juice extruder after using. However, the advantages and drawbacks of a manual juice extruder are opposite to those of the electric juice extruder. Therefore, a user may choose to buy an electric juice extruder or a manual juice extruder according to his demands.

Among the aforementioned juice extruders, if a small amount of juice is to be extruded, most users will still choose to use a manual rotary juice-extruding tray. As shown in FIG. 1, such kind of juice-extruding tray is designed to have a juice-extruding tray 1 that can be disposed on a receiving device. The central position of the juice-extruding tray has a raised portion 2 that protrudes upwardly. The periphery of the raised portion has a plurality of protruding ribs 3. Further, a valley portion 4 is formed between the inner periphery of the juice-extruding tray 1 and the bottom edge of the raised portion. The valley portion 4 has a plurality of penetrating holes 5. Via the above arrangement, the juice-extruding tray 1 can be disposed on a receiving device 6 such as a cup or kettle. Therefore, the user can press a fruit on the top of the raised portion 2 and rotate the fruit, so that the protruding ribs 3 of the raised portion 2 can rub against the fruit flesh to extrude out the juice. The extruded juice will drop into the receiving device 6 via the penetrating holes 5, so that the user can drink the juice collected in the receiving device.

The aforementioned juice-extruding tray is a simple and convenient tool for extruding juice manually, however, the top of the raised portion does not have a skid-proof effect. Therefore, when the user presses and rotates the fruit on the raised portion, the fruit body may move slightly, affecting the operation of extruding the juice and making the user feel inconvenient.

Moreover, when the user applies a force to press and rotate the fruit, a slight movement of the fruit body may change the direction of the applied force. As a result, the user may overturn the receiving device carelessly, causing the lost of juice.

### SUMMARY OF THE INVENTION

The present invention is to provide a manual juice extruder comprising a juice-extruding tray. The central position of the juice-extruding tray has a raised portion that protrudes upwardly. The periphery of the raised portion has a plurality of protruding ribs. The center of the raised portion has an opening. The periphery of the opening has at least one skid-proof piercing portion that protrudes upwardly. Via this arrangement, when the user extrudes the juice manually, the fruit body can be fixed on the raised portion, which facilitates the extrusion of the juice.

The manual juice extruder in accordance with the present invention can be applied to extrude the juice of fruit, such as orange, lemon and etc., and can facilitate the user to carry out the juice-extruding operation. The manual juice extruder of the present invention can be used as a tool for extruding the juice manually and comprises a juice-extruding tray. The central position of the juice-extruding tray has a raised portion that protrudes upwardly. The periphery of the raised portion has a plurality of protruding ribs. The center of the raised portion has an opening. The periphery of the opening has at least one skid-proof piercing portion that protrudes upwardly. Via this arrangement, when the user extrudes the juice manually, the fruit body can be fixed on the raised portion, which facilitates the extrusion of the juice.

In order to make those skilled in this art to understand the objects, characteristics and effects of the present invention, a detailed description relating to a preferred embodiment will be made with reference to the accompanying drawings.

### BRIEF DESCRIPTION OF THE DRAWINGS

FIG. 1 is a schematic view of a conventional manual juice extruder;

FIG. 2 is an exploded perspective view of the manual juice extruder of the present invention;

FIG. 3 is an assembled perspective view of the manual juice extruder of the present invention;

FIG. 4 is a cross-sectional view of the manual juice extruder taken along the line A-A in FIG. 3;

FIG. 5 is a schematic view showing the manual juice extruder of a preferred embodiment of the present invention; and

FIG. 6 is a schematic view showing that the manual juice extruder of the present invention is stored when not in use.

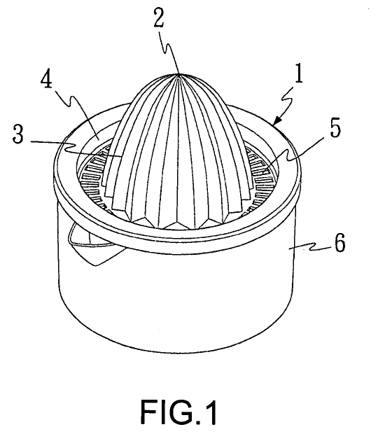

### DETAILED DESCRIPTION OF THE INVENTION

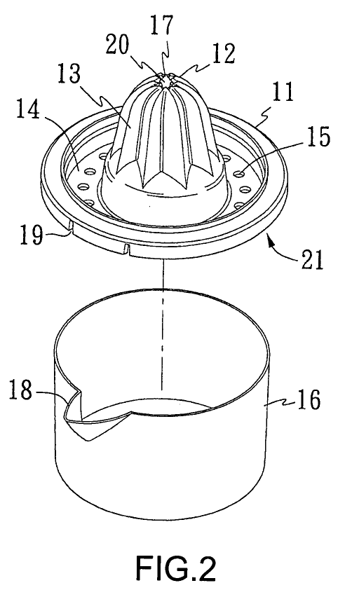

With reference to FIG. 2, it shows an embodiment of the manual juice extruder of the present invention. The manual juice extruder is a juice-extruding tray 11. The central position of the juice-extruding tray has a raised portion 12 that protrudes upwardly. The periphery of the raised portion has a plurality of protruding ribs 13. The center of the raised portion 12 has an opening 20. The periphery of the opening has a plurality of skid-proof piercing portions 17 that protrude upwardly. Further, a valley portion 14 is formed between the inner periphery of the juice-extruding tray 11 and the bottom edge of the raised portion 12. The valley portion 14 has a plurality of penetrating holes 15. The periphery of the juice-extruding tray 11 has a notch 19 corresponding to an outwardly protruding outlet 18 of the receiving device 16.

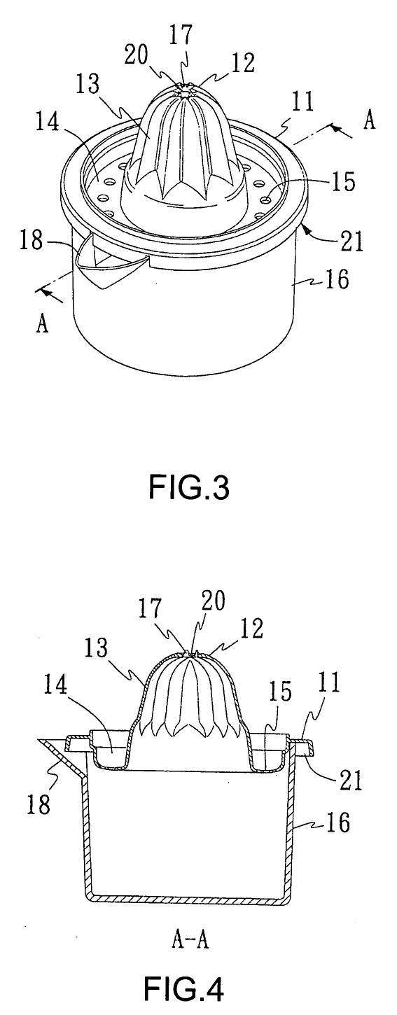

FIG. 3 is an assembled view showing a preferred embodiment in which the juice-extruding tray 11 shown in FIG. 2 is combined with the receiving device 16.

FIG. 4 is a cross-sectional view taken along the line A-A of FIG. 3.

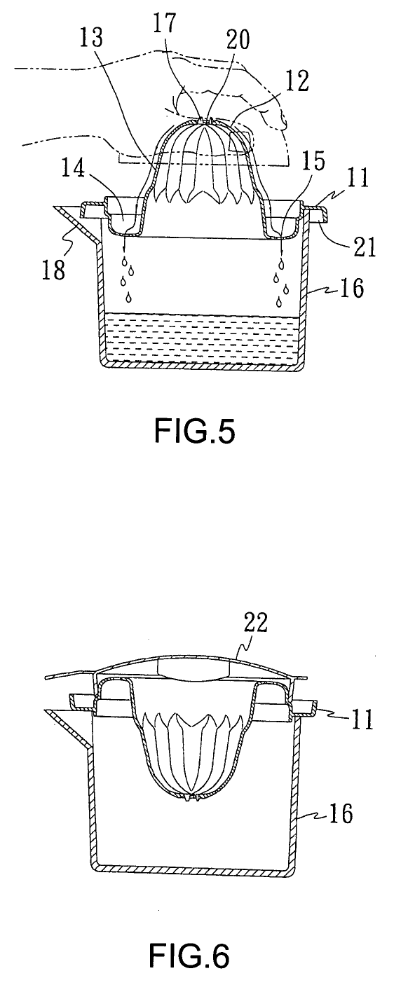

FIG. 5 is a schematic view showing the manual juice extruder in accordance with an embodiment of the present invention. With reference to FIG. 2, the periphery of the juice-extruding tray 11 has an annular insertion portion 21 that can be inserted in and fixed to the upper opening of the receiving device 16 correspondingly. After the user disposes the juice-extruding tray 11 in the receiving device 16 such as a cup, the user can press the fruit (such as orange, lemon and etc.) on the raised portion 12 of the juice-extruding tray 11 and rotate the fruit. The top of the raised portion 12 has an opening 20. The periphery of the opening 20 is provided with the skid-proof piercing portions 17 that are capable of piercing through and fixing the fruit flesh. Then, the protruding ribs 13 of the raised portion 12 rub against the fruit flesh to extrude out the juice. The extruded juice drops into the receiving device 16 (such as a cup) via the penetrating holes 15 of the juice-extruding tray 11 and is collected therein. Finally, the juice can be drained out via the outlet 18 of the receiving device 16, so that the user can drink it.

FIG. 6 is a schematic view showing that the manual juice extruder of the present invention is stored when not in use. After the user finishes extruding the juice, the user can dispose the juice-extruding tray 11 with the raised portion 12 thereof facing toward the bottom of the receiving device 16. Further, a cup cover 22 is provided to act as a cover body, in which the top surface thereof has a grip portion to allow the user to grip it. The cover is covered on the juice-extruding tray 11 and the receiving device 16, thereby saving the space for storage.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A manual juice extruder, comprising:
a juice-extruding tray provided at a central position thereof with a raised portion that protrudes outwardly, the periphery of the raised portion having a plurality of protruding ribs, the center of the raised portion having an opening, and the periphery of the opening having at least one skid-proof piercing portion that protrudes outwardly.

2. The manual juice extruder according to claim 1, wherein a valley portion is formed between the inner periphery of the juice-extruding tray and the bottom edge of the raised portion, and the valley portion has a plurality of penetrating holes.

3. The manual juice extruder according to claim 1, further comprising a receiving device, the top of the receiving device having an opening for receiving the juice flowing through the penetrating holes of the valley portion.

4. The manual juice extruder according to claim 3, wherein the upper edge of the receiving device further comprises an outwardly protruding outlet.

5. The manual juice extruder according to claim 3, wherein the periphery of the juice-extruding tray has an annular insertion portion that allows to be inserted into and fixed to the upper opening of the receiving device correspondingly.

6. The manual juice extruder according to claim 5, wherein the periphery of the annular insertion portion has at least one notch corresponding to the outlet.

7. The manual juice extruder according to claim 3, further comprising a cover, the top surface of the cover having a grip portion to allow a user to grip it, the cover being capable of covering on the receiving device.
